(19) United States
(12) Patent Application Publication
(10) Pub. No.: US 2026/0017359 A1
(43) Pub. Date: Jan. 15, 2026

(54) USER AND ENTITY BEHAVIORAL ANALYTICS IN SECURITY ANALYTICS PLATFORM

(71) Applicant: Google LLC, Mountain View, CA (US)

(72) Inventors: Michael Hom, Arlington, VA (US); Travis Lanham, Sunnyvale, CA (US); Amarendra Pendala, San Francisco, CA (US)

(21) Appl. No.: 19/262,580

(22) Filed: Jul. 8, 2025

Related U.S. Application Data
(60) Provisional application No. 63/669,022, filed on Jul. 9, 2024.

(51) Int. Cl. G06F 21/42; G06F 21/36

(52) U.S. Cl. CPC G06F 21/42; G06F 21/36

(57) ABSTRACT

A system and method for implementing user and entity behavioral analytics (UEBA) in a cybersecurity analytics platform. An example method includes receiving, by one or more processing devices of a security analytics platform, security data associated with a specified entity; generating, based on at least a subset of the security data, one or more security signals associated with the specified entity and occurring within a specified time window; computing, for each security signal of the one or more security signals, a respective risk score associated with the specified time window; computing, by aggregating risk scores associated with the one or more security signals, a risk score associated with the specified entity for the specified time window; and modifying, based on an attribute of a security watchlist associated with the specified entity, the risk score of the specified entity.

### REFERENCE TO RELATED APPLICATION

This application claims the priority benefit of U.S. Provisional Patent Application No. 63/669,022, filed Jul. 9, 2024, the entirety of which is incorporated herein by reference.

### TECHNICAL FIELD

The present disclosure relates generally to cloud-based security analytics platforms. In particular, aspects and implementations of the present disclosure relate to implementing user and entity behavioral analytics (UEBA) in a security analytics platform.

### BACKGROUND

In today's digital age, organizations are constantly facing an increasing volume of sophisticated cybersecurity threats. Cybersecurity is the practice of protecting systems, networks, and data from digital attacks, unauthorized access, and damage. Traditional cybersecurity measures are often inadequate in providing comprehensive protection against such threats, which has resulted in the proliferation of large numbers of disparate cybersecurity operations tools such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. These platforms and system can generate multiple alerts for each detection of a security threat. Because not all security threats are of equal importance, it can be challenging to sift through a large quantity of security threats. Analyzing and acting upon the staggering volume of security threats generated by such an ever-increasing number of cybersecurity operations tools is complex and cumbersome, leading to inefficiencies and vulnerabilities.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for implementing user and entity behavioral analytics (UEBA) in a security analytics platform. In an implementation, a method includes receiving, by one or more processing devices of a security analytics platform, security data associated with a specified entity; generating, based on at least a subset of the security data, one or more security signals associated with the specified entity and occurring within a specified time window; computing, for each security signal of the one or more security signals, a respective risk score associated with the specified time window; computing, by aggregating risk scores associated with the one or more security signals, a risk score associated with the specified entity for the specified time window; and modifying, based on an attribute of a security watchlist associated with the specified entity, the risk score of the specified entity.

In some implementations, generating the one or more security signals further includes: responsive to determining that values of one or more security data items associated with the specified entity satisfy a logical condition specified by a signal creation rule, generating a signal specified by the signal creation rule.

In some implementations, generating the one or more security signals further includes: responsive to determining that values of one or more security data items associated with the specified entity satisfy a logical condition specified by a signal attribute computation rule, computing one or more signal attribute values to be assigned to respective one or more signal attributes associated with the signal.

In some implementations, the watchlist is identified by a watchlist membership rule, and the method further includes: responsive to determining that values of one or more attributes of the specified entity satisfy a logical condition specified by the watchlist membership rule, associating the specified entity with the watchlist.

In some implementations, the watchlist is identified by a watchlist membership rule, and the method further includes: responsive to determining that values of one or more attributes of the specified entity fail to satisfy a logical condition specified by the watchlist membership rule, disassociating the specified entity from the watchlist.

In some implementations, modifying the risk score of the specified entity further includes: multiplying the risk score by the attribute of the security watchlist.

In some implementations, the method further includes: rendering, via a graphical user interface (GUI) a visual representation of the security risk in visual association with a timeline comprising the specified time window.

An aspect of the disclosure provides a system including a memory device and a processing device communicatively coupled to the memory device. The processing device performs the method as described above.

An aspect of the disclosure provides a computer-readable storage medium (which can be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, in accordance with aspects of the disclosure.

FIG. 2 is an example illustration of a security taxonomy, in accordance with aspects of the disclosure.

FIG. 3 illustrates a display screen with a graphical user interface for editing entity risk score parameters, generated by a security analytics platform operating in accordance with aspects of the present disclosure.

FIG. 4 illustrates a display screen with a graphical user interface visually representing the summary user and entity behavior analytic (UEBA) metrics generated by a security analytics platform operating in accordance with aspects of the present disclosure.

FIG. 5 illustrates a display screen with a graphical user interface visually representing the risk score and findings timeline generated by a security analytics platform operating in accordance with aspects of the present disclosure.

FIG. 6 illustrates a display screen with a graphical user interface visually representing the risk score and findings timeline in a visual association with a chosen parameter timeline, generated by a security analytics platform operating in accordance with aspects of the present disclosure.

FIG. 7 illustrates a display screen with a graphical user interface for visually representing parameters of selected watchlists, generated by a security analytics platform operating in accordance with aspects of the present disclosure.

FIG. 8 illustrates a display screen with a graphical user interface for editing parameters of a watchlist, generated by a security analytics platform operating in accordance with aspects of the present disclosure.

FIG. 9 is a high-level flow diagram of an example method of computing entity risk scores by a security analytics platform operating in accordance with aspects of the present disclosure.

FIG. 10 is a high-level flow diagram of an example method of watchlist management by a security analytics platform operating in accordance with aspects of the present disclosure.

FIG. 11 is a block diagram illustrating an example of a computer system, according to aspects of the disclosure.

### DETAILED DESCRIPTION

Aspects of the present disclosure relate to implementing user and entity behavioral analytics (UEBA) in a security analytics platform. A security analytics platform can serve one or more clients (e.g., represented by entities such as organizations). The security analytics platform can be part of an online (e.g., virtual) platform that provides clients with a comprehensive suite of productivity tools, programs, and services. The security analytics platform can combine the features of Security Information and Event Management (SIEM) and a Security Orchestration, Automation, and Response (SOAR) into a unified platform. The security analytics platform can collect logs from a client and provide its clients with tools to detect, analyze, and respond to incidents described in the collected logs. One or more features of the security analytics platform can be automated or partially automated, including log collection actions, incident detection actions, data analysis actions, or incident response actions.

The security analytics platform can provide a client organization with tools to manage computer and network security for the client. The security analytics platform can provide a user (e.g., a systems administrator) from the client organization with a graphical user interface (GUI) to access and use the tools and functionality of the security analytics platform.

The client organization can provide security data (e.g., ingested data) to the security analytics platform. As used herein, security data can include telemetry data such as log files produced by the operating systems, middleware, and/or applications that reflect actions which occurred at specific moments in time on a computing resource. Once the security analytics platform receives the ingested data from the client organization, the client organization can use the tools or services of the security analytics platform to perform security actions with the ingested data. The security actions of the security analytics platform can generate one or more of events, detections, or alerts from the ingested data. Some security analytics platforms can provide notifications based on the events, detections or alerts that are generated.

The security analytics platform can perform rule-based processing of security data. When a security rule is applied to security data, the security data is evaluated against a logical condition specified by the rule. If the security data satisfies the logical condition, the action specified by the security rule is performed, thus producing the outcome of the rule. Security rule outcomes can include a security signal (such an event, a detection (e.g., of a security threat), an alert (e.g., of a security threat)) and/or a corrective action to be performed (e.g., modification of a configuration of an entity referenced by the rule, such as a computer system).

“Security entity” or “entity” herein refers to an element belonging to or associated with a given computing environment (e.g., a computing environment of an organization served by the security analytics platform). Examples of entities include servers, computers, portable communication devices, networks, network addresses, infrastructure elements (such as switches, routers, firewalls, etc.), virtual machines, secure execution environments, applications, middleware, operating systems, hardware security modules, organizations, organizational units, individual users, etc.

In some implementations, the security analytics platform can implement User and Entity Behavior Analytics (UEBA) and advanced analytics capabilities to support a broad set of client use cases spanning detection, investigation, and response workflows. The security analytics platform can enable a risk-based lens across multiple layers of a client's attack surface; correlate heterogeneous signals from heuristic, statistical, metric-based, and algorithmic sources; deliver statistically enriched corroborative signals to augment detection and investigation; perform detection of multi-stage attacks using behavioral inference.

In some implementations, the security analytics platform can utilize various contributing factors related to detection events to compute a respective risk score for each entity of a computing environment (e.g., an organization). The security analytics platform can consider both the severity and the count of detections when computing the risk score for a given entity.

In some implementations, the security analytics platform can generate sets of precomputed observation and occurrence metrics, which can then be used in conjunction with statistical analytics as inputs to the detection and risk score computation logic.

In some implementations, the security analytics platform can generate risk scores at multiple levels, including individual entities, groups or clusters of entities, and the full environment or attack surface.

The computed risk scores can be visualized in monitoring and investigative dashboards, signal graph overlays, complementary risk dashboards listing entity-level scores, and/or various other GUI screens.

In an illustrative example, one or more of the specified security entities can be referenced by a security watchlist maintained by the security analytics platform. The security analytics platform can use watchlists to modify (e.g., elevate or suppress) the magnitude of the perceived risk associated with the entity.

A security watchlist can include a list of entities and associated metadata. The security analytics platform can implement various watchlist management functions, including creating, modifying, and deleting watchlists.

In some implementations, the security analytics platform can apply one or more watchlist attributes to modify the risk scores of the entities that are members of the watchlist. In an illustrative example, one or more watchlist attributes can specify respective multiplicative factors for adjusting the weights of certain signals that are utilized for computing a risk score of an entity referenced by the watchlist. In another illustrative example, a watchlist attribute can specify a multiplicative factor for adjusting the risk score of an entity referenced by the watchlist. In some implementations, the security analytics platform can apply the multiplicative factors at the time of risk score computation without modifying the underlying alert risk scores or detection risk scores, as described in more detail herein below.

Thus, the security analytics platform implementing the methods described herein improves the functioning of distributed computing environments by facilitating efficient threat detection, alerting, and incident response. In particular, UEBA and advanced analytics capabilities improve the functioning of distributed computing environments by supporting a broad set of client use cases spanning detection, investigation, and response workflows. Furthermore, computing per-entity risk scores which take into account both the severity and the count of detections improves the functioning of distributed computing environments by providing quantitative measures of risks associated with each entity of a distributed computing environment. Besides, generating risk scores at multiple levels, including individual entities, groups or clusters of entities, and the full attack surface improves the functioning of distributed computing environments by providing quantitative measures at every level of a distributed computing environment. Moreover, implementing watchlists and using them to modify the magnitude of the perceived risk associated with an entity improves the functioning of distributed computing environments by providing more accurate quantitative measures associated with entities or group of entities of a distributed computing environment. Also, apply one or more watchlist attributes to modify the risk scores of the entities that are members of the watchlist improves the functioning of distributed computing environments by providing more accurate quantitative measures associated with entities or group of entities of a distributed computing environment. Finally, visualizing the computed risk scores in monitoring and investigative dashboards, signal graph overlays, complementary risk dashboards listing entity-level scores, and/or various other GUI screens improves the functioning of distributed computing environments by providing visual representations of the computed quantitative measures of risks associated with each entity or level of a distributed computing environment.

Various aspects of the methods and systems are described herein by way of examples, rather than by way of limitation. The systems and methods described herein may be implemented by hardware (e.g., general purpose and/or specialized processing devices, and/or other devices and associated circuitry), software (e.g., instructions executable by a processing device), or a combination thereof.

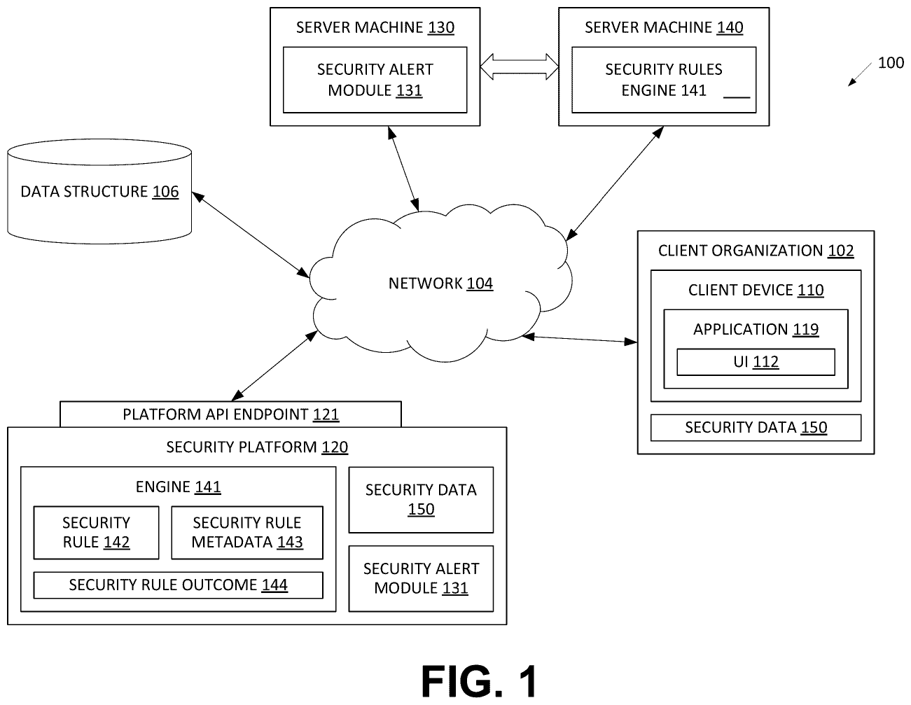

FIG. 1 illustrates an example of a system 100, in accordance with aspects of the disclosure. The system 100 includes a security analytics platform 120, one or more server machines 130-140, a data structure 106, and client organization 102 connected to network 104. In some implementations, system 100 can include one or more other platforms (not illustrated).

In some implementations, network 104 can include a public network (e.g., the Internet), a private network (e.g., a local area network (LAN) or wide area network (WAN)), a wired network (e.g., Ethernet network), a wireless network (e.g., an 702.11 network or a wireless fidelity (Wi-Fi) network), a cellular network (e.g., a Long Term Evolution (LTE) network), routers, hubs, switches, server computers, and/or a combination thereof.

Data structure 106 can be a persistent storage that is capable of storing data such as log information (e.g., sequences of characters in a log), labels reflecting a type of log, and the like. Data structure 106 can be hosted by one or more storage devices, such as main memory, magnetic or optical storage based disks, tapes or hard drives, network-attached storage (NAS), storage area network (SAN), and so forth. In some implementations, data structure 106 can be a network-attached file server, while in other implementations the data structure 106 can be another type of persistent storage such as an object-oriented database, a relational database, and so forth, that can be hosted by security analytics platform 120, or one or more different machines coupled to the server hosting the security analytics platform 120 via the network 104. In some implementations, data structure 106 can be capable of storing one or more data items, as well as data structures to tag, organize, and index the data items. A data item can include various types of data including structured data, unstructured data, vectorized data, etc., or types of digital files, including text data, audio data, image data, video data, multimedia, interactive media, data objects, and/or any suitable type of digital resource, among other types of data. An example of a data item can include a file, database record, database entry, programming code or document, among others.

The client organization 102 can include one or more client device(s) (e.g., client device 110). Each client device 110 can include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 110 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components. In some implementations, client device(s) can also be referred to as a “user device” herein. Although a single client device 110 is shown for purposes of illustration rather than limitation, one or more client devices can be implemented in some implementations. Client device 110 will be referred to as client device 110 or client devices 110 interchangeably herein.

In some implementations, a client device, such as client device 110, can implement or include one or more applications. In some implementations, application 119 can be used to communicate (e.g., send and receive information) with the security analytics platform 120. In some implementations, application 119 can implement user interfaces (Uis) (e.g., graphical user interfaces (GUIs)), such as a user interface (UI) (e.g., UI 112) that can be webpages rendered by a web browser and displayed on the client device 110 in a web browser window. In another implementation, the UIs 112 of client application, such as application 119 can be included in a stand-alone application downloaded to the client device 110 and natively running on the client device 110 (also referred to as a “native application” or “native client application” herein). In some implementations, engine 141 can be implemented as part of application 119. In other implementations, engine 141 can be separate from application 119 and application 119 can interface with engine 141.

In some implementations, one or more client devices 110 can be connected to the system 100. In some implementations, client devices, under direction of the security analytics platform 120 when connected, can present (e.g., display) a UI 112 to a user of a respective client device through application 119. The client devices 110 can also collect input from users through input features.

In some implementations, a UI 112 can include various visual elements (e.g., UI elements) and regions, and can be a mechanism by which the user engages with the security analytics platform 120, and system 100 at large. In some implementations, the UI 112 of a client device 110 can include multiple visual elements and regions that enable presentation of information, for decision-making, content delivery, etc. at a client device 110. In some implementations, the UI 112 can sometimes be referred to as a graphical user interface (GUI)).

In some implementations, the UI 112 and/or client device 110 can include input features to intake information from a client device 110. In one or more examples, a user of client device 110 can provide input data (e.g., a user query, control commands, etc.) into an input feature of the UI 112 or client device 110, for transmission to the security analytics platform 120, and system 100 at large. Input features of UI 112 and/or client device 110 can include space, regions, or elements of the UI 112 that accept user inputs. For example, input features can include visual elements (e.g., GUI elements) such as buttons, text-entry spaces, selection lists, drop-down lists, etc. For example, in some implementations, input features can include a chat box which a user of client device 110 can use to input textual data (e.g., a user query). The application 119 via client device 110 can then transmit that textual data to security analytics platform 120, and the system 100 at large, for further processing. In other examples, input features can include a selection list, in which a user of client device 110 can input selection data e.g., by selecting, or clicking. The application 119 via client device 110 can then transmit that selection data to security analytics platform 120, and the system 100 at large, for further processing.

In some implementations, a client device 110 can access the security analytics platform 120 through network 104 using one or more application programming interface (API) calls via platform API endpoint 121. In some implementations, security analytics platform 120 can include multiple platform API endpoints 121 that can expose services, functionality, or information of the security analytics platform 120 to one or more client devices 110. In some implementations, a platform API endpoint 121 can be one end of a communication channel, where the other end can be another system, such as a client device 110 associated with a user account. In some implementations, the platform API endpoint 121 can include or be accessed using a resource locator, such a universal resource identifier (URI), universal resource locator (URL), of a server or service. The platform API endpoint 121 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 121.

In some implementations, the platform API endpoint 121 can function as a computer interface through which access requests are received and/or created. In some implementations, the platform API endpoint 121 can include a platform API whereby external entities or systems can request access to services and/or information provided by the security analytics platform 120. The platform API can be used to programmatically obtain services and/or information associated with a request for services and/or information.

In some implementations, the API of the platform API endpoint 121 can be any suitable type of API such as a REST (Representational State Transfer) API, a GraphQL API, a SOAP (Simple Object Access Protocol) API, and/or any suitable type of APL In some implementations, the security analytics platform 120 can expose through the API, a set of API resources which when addressed can be used for requesting different actions, inspecting state or data, and/or otherwise interacting with the security analytics platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the security analytics platform 120 can observe the principals of a RESTful design or the protocol of the type of APL RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some implementations, any element, such as server machine 130, server machine 140, and/or data structure 106 can include a corresponding API endpoint for communicating with APIs.

In some implementations, the security analytics platform 120 can include one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to data or services. Such computing devices can be positioned in a single location or can be distributed among many different geographical locations. For example, security analytics platform 120 can include a plurality of computing devices that together can comprise a hosted computing resource, a grid computing resource, or any other distributed computing arrangement. In some implementations, the security analytics platform 120 can correspond to an elastic computing resource where the allotted capacity of processing, network, storage, or other computing-related resources can vary over time.

In some implementations, the security analytics platform 120 can include one or more features to collect, analyze, and respond to security data 150 received from a client organization 102. The security analytics platform can collect the security data 150 from the client organization 102. In some implementations, the security analytics platform 120 includes one or more security data ingestion points. In some implementations, one or more aspects of the collection of the security data 150 the client organization 102 are automated or partially automated. In some implementations, the security data 150 can be stored in the data structure 106. The security analytics platform 120 can provide the client organization 102 with tools to analyze the security data 150.

Security data 150 can be obtained (e.g., generated) by the client organization 102 and can include information describing activities in a computing environment of the client organization 102 (e.g., including client device 110, application 119, etc.). In some implementations, the security data 150 includes details about the activity that the client organization 102 can use to analyze the activity, respond to an event, or implement policies to avoid, or promote similar activity in the future. In some implementations, tools, applications, or systems of or used by the client organization 102 can generate security data 150. In some implementations, the security analytics platform 120 can receive security data 150 generated by a client organization 102. For example, and in some implementations, the client organization 102 can provide the security analytics platform 120 with security data 150 as an automated or semi-automated process. In some implementations, the security data 150 are received one at a time. In some implementations, the security data 150 are received as a list, group, table, or other data structure. In some implementations, one or more of security data 150 are received discreetly (e.g., at specific times). In some implementations, the security data 150 are received as a real-time data stream.

In some implementations, the security data 150 includes one or more entries, such as temporal data (e.g., a timestamp), an event description, network data (e.g., internet protocol (IP) address(es), network traffic data, or network configuration data), a user identification, system information (e.g., a computing environment of the client), security context information, or the like. In some implementations, the security data 150 includes information related to the client organization 102. For example, security data 150 from Organization A using Application X can include Organization A information and Application X information, while security data from Organization B using Application X can only include Application X information. In some implementations, the security data 150 can include organization-specific data. In some implementations, a portion of the security data 150 for logs received from different organizations (e.g., client organization 102) can be the same or similar.

In some implementations, the security data can be labeled or tagged to allow, e.g., efficient correlation of various data items that can be related to a common set of entities and/or can share a common set of parameters. In some implementations, one or more aspects of the tools to analyze the information extracted from the security data 150 can be automated or partially automated. The security analytics platform 120 can provide the client organization 102 with tools to perform one or more security actions based on information extracted from the security data 150 received from the client organization 102. In some implementations, the security analytics platform 120 can allow the client organization 102 to configure certain security response parameters related to performing one or more actions based on information extracted from the security data 150. For example, the security analytics platform 120 can allow the client to indicate a particular security action that is to be triggered when a security rule produces an outcome. In some implementations, one or more aspects of the tools to perform one or more actions based on the information extracted from the security data 150 can be automated or partially automated.

The security analytics platform 120 can implement a security data processing engine 141. The engine 141 can implement one or more features and/or operations as described herein. In some implementations, engine 141 can include or access an artificial intelligence (AI) model (e.g., a machine learning model) to perform the one or more features and/or operations (not illustrated). In some implementations, the security analytics platform 120 receives security data 150 from the client organization 102. Security data 150 can include data that pertains to security data (e.g., security logs) received from the client organization 102. The engine 141 can process the security data 150 to obtain a security rule outcome 144. In some implementations, the engine 141 can process additional inputs, including security rule metadata 143, and security rule outcomes 144 from previously performed security rules 142. The engine 141 can include or interface with a GUI (e.g., UI 112) to provide users of a client device 110 of a client organization 102 with a user interface to configure one or more parameters of the engine 141. For example, the UI 112 can be used to define one or more security rules. In some implementations, security rule metadata 143 can include one or more of data type identifiers, data labels, a source of the security data 150, or the like.

In some implementations, the engine 141 applies one or more of the security rules 142 to one or more subsets of the ingested security data 150. In some implementations, the client organization 102 configures parameters of the security analytics platform 120 based on one or more security rules. Each security rule can be configured individually, e.g., via manipulating visual objects and controls rendered by a graphical user interface and/or creating or editing formal rule definitions in a predefined scripting language. Once rule is configured, it can automatically be applied to the ingested data.

In an illustrative example, the engine 141 can provide an outcome from a security rule to the security alert module 131 of the security analytics platform 120. In some implementations, the security alert module 131 can generate a notification for a specified outcome of the security rule.

In some implementations, the engine 141 (e.g., via the security analytics platform 120) can generate, modify, and monitor the client-side UIs (e.g., graphical user interfaces (GUI)) and associated components that are presented to users of the security analytics platform 120 through UI 112 client devices 110. For example, engine 141 can generate the UIs (e.g., UI 112 of client device 110) that users interact with while engaging with the security analytics platform 120.

In some implementations, a machine learning model (e.g., also referred to as an “artificial intelligence (AI) model” herein) can include a discriminative machine learning model (also referred to as “discriminative AI model” herein), a generative machine learning model (also referred to as “generative AI model” herein), and/or other machine learning model.

In some implementations, a discriminative machine learning model can model a conditional probability of an output for given input(s). A discriminative machine learning model can learn the boundaries between different classes of data to make predictions on new data. In some implementations, a discriminative machine learning model can include a classification model that is designed for classification tasks, such as learning decision boundaries between different classes of data and classifying input data into a particular classification. Examples of discriminative machine learning models include, but are not limited to, support vector machines (SVM) and neural networks.

In some implementations, a generative machine learning model learns how the input training data is generated and can generate new data (e.g., original data). A generative machine learning model can model the probability distribution (e.g., joint probability distribution) of a dataset and generate new samples that often resemble the training data. Generative machine learning models can be used for tasks involving image generation, text generation and/or data syn-thesis. Generative machine learning models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

In some implementations, server machine 130 and server machine 140 can be one or more computing devices (such as a rackmount server, a router computer, a server computer, a personal computer, a mainframe computer, a laptop computer, a tablet computer, a desktop computer, etc.), data structures (e.g., hard disks, memories, databases), networks, software components, or hardware components that can be used to provide a user with access to one or more data items of the security analytics platform 120. The security analytics platform 120 can also include a website (e.g., a webpage) or application back-end software that can be used to provide users with access to the security analytics platform 120.

In some implementations, one or more of the server machine 130 or the server machine 140 can be part of the security analytics platform 120. In other implementations, one or more of the server machine 130 or the server machine 140 can be separate from security analytics platform 120 (e.g., provided by a third-party service provider).

In general, functions described in implementations as being performed by security analytics platform 120, client organization 102, and/or server machine 140 can also be performed on the client device 110 in other implementations, if appropriate. In addition, the functionality attributed to a specific component can be performed by different or multiple components operating together. The security analytics platform 120 can also be accessed as a service provided to other systems or devices through appropriate application programming interfaces, and thus is not limited to use in websites.

In implementations of the disclosure, a “user” can be represented as a single individual. For example, a user of the client device 110. However, other implementations of the disclosure encompass a “user” being an entity controlled by a set of users and/or an automated source (e.g., client organization 102). For example, a set of individual users federated as a community in a social network can be considered a “user.” In another example, an automated consumer can be an automated ingestion pipeline of security analytics platform 120.

Further to the descriptions above, a user can be provided with controls allowing the user to make an election as to both if and when systems, programs, or features described herein can enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a specific location of a user cannot be determined. Thus, the user can have control over what information is collected about the user, how that information is used, and what information is provided to the user.

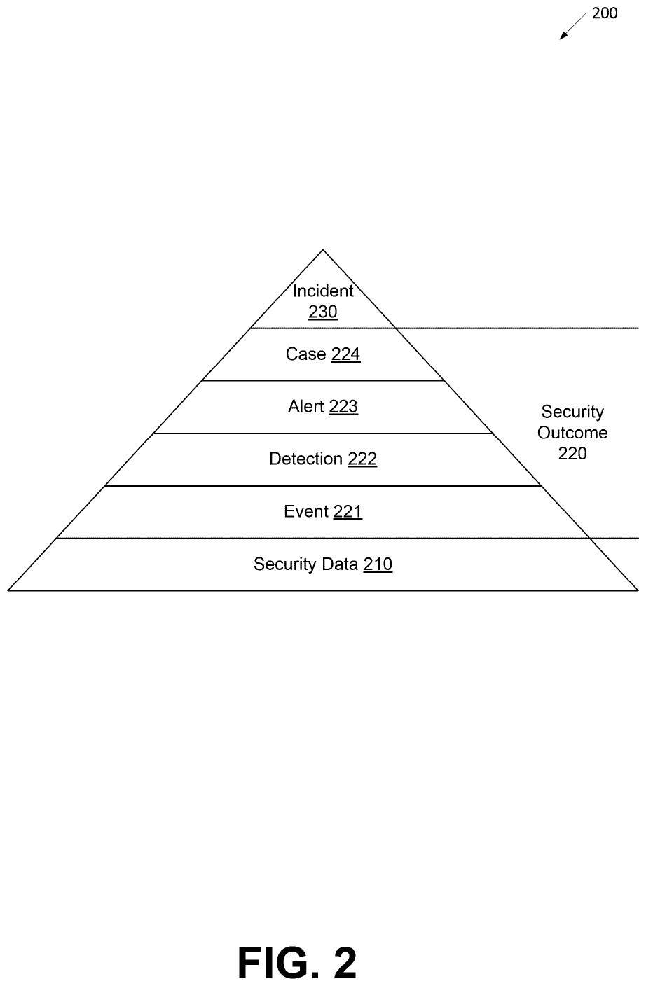

FIG. 2 is an example illustration of a security taxonomy 200, in accordance with aspects of the disclosure. Security taxonomy 200 includes security data 210, event 221, detection 222, alert 223, case 224, and incidents 230. As used herein, security outcome 220 can include one or more of an event 221, a detection 222, an alert 223, or a case 224. Generally, incidents 230 can refer to any of one or more of an event 221, a detection 222, an alert 223, or a case 224 that exceeds a threat-level threshold condition, as defined by the security analytics platform and/or an organization using the security analytics platform. In some implementations, security outcome 220 can include incidents 230. It can be appreciated that the security taxonomy 200 is included herein to define, and provide examples of “security outcomes” (e.g., security outcome 220), which is meant to be an inclusive representation and definition, rather than an exclusive representation and definition.

Security data 210 can include all data generated by an organization (e.g., client organization 102) that is sent to a security analytics platform (e.g., security analytics platform 120) for processing (e.g., ingested data). As described above, security data 210 can include telemetry data. The security analytics platform can process the security data 210 using one or more security rules. As described above, a security rule is a defined set of criteria and instructions used to process the security data (and/or outcomes from other security rules).

Security data 210 can be processed by a security rule into a security outcome 220, which can include one or more of an event 221, a detection 222, an alert 223, or a case 224. In some implementations, once security data 210 is processed by a security rule, the resulting data is a security outcome 220 (e.g., one of an event 221, a detection 222, an alert 223, or a case 224), or an incident 230.

The security analytics platform can process the event 221 using one or more security rules. An event 221 can refer to security data 210 that has been processed to include additional context or significance that indicates a noticeable change in the state of a computing system. In some implementations, the additional context or significance can be included or represented as a label or tag. In some implementations, the additional context or significance can be added as metadata to the processed security data (e.g., security data 210) to generate the event 221. In some implementations, multiple sets of security data 210 can be processed by a single security rule to generate an event 221. An event 221 can be processed by a security rule into another security outcome 220, including one or more of another security event (e.g., event 221), a detection 222, an alert 223, or a case 224. In some implementations, the event 221 can be processed into an incident 230.

The security analytics platform can process the detection 222 using one or more security rules. A detection 222 can refer to an object that is generated from matched or correlated security events (e.g., event 221) that pertains to an indication, or potential indication of a security threat. A detection 222 can include an analytical assessment of an event 221, and/or security data 210. In some implementations, data used to generate the detection 222 (e.g., security data 210, event 221, another detection, etc.) can be matched or correlated by an algorithm or machine learning model. In some implementations, the detection 222 can be generated from a security rule based on security data 210. In some implementations, the detection 222 can be generated from a security rule based on event 221 and security data 210. Detection 222 can be processed by a security rule into another security outcome 220, including one or more of another security detection (e.g., a detection 222), an alert 223 or a case 224. In some implementations, detection 222 can be processed into an incident 230.

The security analytics platform can process the alert 223 using one or more security rules. An alert 223 can refer to a security outcome 220 that satisfies an alert threshold criterion. An alert 223 can be a detection 222 that satisfies the alert threshold criterion. In some implementations, the security outcome 220 can satisfy an alert threshold based on one or more characteristics of the security outcome 220. Characteristics of security outcomes 220 can be reflected in metadata associated with the security outcome 220. In some implementations, a security rule can process one or more of security data 210, an event 221, a detection 222, or other alert 223 to determine whether the processed data satisfies the alert threshold. An alert 223 can be processed by a security rule into another security outcome 220, including one or more of another security alert (e.g., an alert 223) or a case 224. In some implementations, the alert 223 can be processed into an incident 230.

The security analytics platform can process the case 224 using one or more security rules. A security case (e.g., case 224) can refer to a collection of one or more security alerts (e.g., alert 223), detections (e.g., detection 222), events (e.g., event 221), and/or security data 210 that have one or more of the same or similar characteristics (e.g., metadata). In some implementations, case 224 can be grouped based on temporal characteristics. For example, security outcomes 220 and security data 210 can be grouped into case 224 based on an access time, or processing time associated with the security outcomes 220 or security data 210. Case 224 can be processed by a security rule into another security outcome 220 such as another security case (e.g., case 224). In some implementations, the case 224 can be processed into an incident 230.

The security analytics platform can process an incident 230 based on one or more security rules. An incident 230 can refer to a security outcome 220 that meets one or more criteria for investigation. In some implementations, the investigation that is triggered for the incident 230 can be a manual investigation by security researchers. In some implementations, the investigation that is triggered for the incident 230 can be an automated or semi-automated investigation using one or more of security investigation algorithms, artificial intelligence (AI) models, or the like.

As noted herein above, a security outcome 220 can include one or more of an event 221, a detection 222, an alert 223, an incident 230, or a case 224. Security outcomes 220 can be generated by one or more security rules that process one or more of security data 210, an event 221, a detection 222, an alert 223, or a case 224. For example, a security rule can process the security data 210, a detection 222, and an alert 223 to generate a security outcome 220. In another example, a security rule can process a detection 222 to generate a security outcome 220. In another example, a security rule can process the security data 210 to generate a security outcome 220. In some implementations, security outcomes 220 can be generated by security rules that additionally process data from an incident 230. For example, a security outcome 220 (e.g., a security detection) can be obtained by processing the security data 210 and a detection 222 on a security analytics platform using a security rule. In another example, a security outcome 220 (e.g., a security event) can be obtained by processing the security data 210 and an event 221. In another example, a security outcome 220 (e.g., a security alert) can be obtained by processing the event 221, the detection 222, and the alert 223. Thus, security rules can operate on security data 210 and any of security outcomes 220 to produce another security outcome 220. In some implementations, security outcomes 220 of a lower tier on the security taxonomy 200 are processed by a security rule to generate security outcomes 220 of the same, or a higher tier. For example, event 221 and detection 222 can be processed by a security rule to generate additional detection 222, or alert 223.

In some implementations, the security analytics platform 120 (e.g., via the engine 141) can implement the risk score computation based on user-specified risk score parameters. Computation of the risk scores can be performed for user-configurable time windows. The computed security risk can be visually represented via an entity risk dashboard.

In an illustrative example, the security analytics platform can receive security data associated with one or more security entities. Examples of security entities include: a host, a user, user group, a network address (e.g., an Internet Protocol (IP) address, a Media Access Control (MAC address), and/or a subnet address), etc. The security analytics platform can process at least the subset of the received security data, e.g., by applying one or more security rules, which can be specified by respective definitions in a chosen detection engineering, search, and investigation language (e.g., YARA-L). Each rule can specify a logical condition defined on values of respective items of security data and a rule outcome (e.g., a security signal): if the security data satisfies the logical condition, the security signal specified by the security rule is generated. Examples of security signals include an event, a detection (e.g., of a security threat), an alert (e.g., of a security threat), a third party signal, etc.

In an illustrative example, the security analytics platform can, responsive to determining that values of one or more security data items associated with an entity satisfy a logical condition specified by a signal creation rule, generate a signal specified by the rule. In another illustrative example, responsive to determining that values of one or more security data items associated with an entity satisfy a logical condition specified by a signal attribute computation rule, compute signal attribute values to be assigned to one or more signal attributes associated with a signal.

Based on the security signals yielded by processing the ingested security data, the security analytics platform can compute security risk scores associated with one or more of the specified security entities, as described in more detail herein below.

In another illustrative example, the security risk score can be represented by an entity risk score, which is a numeric value that characterizes the risk that the entity presents to an organizational unit or organization, based on the aggregated, over a chosen time window, risk scores of related security signals associated with the entity. The entities having the largest entity risk scores in an organization can be considered as representing the most severe security risks.

In some implementations, an entity risk score for a given entity can be computed and/or modified based on the attributes of one or more signals associated with the entity. In an illustrative example, a signal can be associated with signal metadata including one or more signal attributes that specify the priority, the severity, and the alert risk score of the signal. In an illustrative example, the alert risk score can be assigned by the detection rule that has generated the alert. In another illustrative example, the priority and the severity of the signal can be user-configurable to reflect specific operational needs.

In another illustrative example, the signal attributes characterize a given signal can specify the type of signal (e.g., an alert, a detection signal, an anomaly, a third party signal, etc.), the time of occurrence of the signal, and/or the frequency of occurrence of the signal. In another illustrative example, the time window associated with a given signal can specify the temporal boundaries for computing the entity risk score (e.g., a specified number of days).

In some implementations, the security analytics platform can assign a risk score to each signal based on the signal attributes. Such assignment can be performed by a configurable logic of the security analytics platform (e.g., a rule engine evaluating one or more rule sets or by an AI-based model). In an illustrative example, the signal risk score can be assigned to a signal by the detection rule that has generated the signal.

In some implementations, the security analytics platform can maintain, for each entity, a corresponding set of entity attributes which can specify the group associations of the entity (e.g., an organizational unit or an employee level), the priority of a given entity (e.g., mission-critical server) for which the risk score is computed, and/or the relationships of the given entity with other entities (e.g., used by a certain group of users).

The risk score computation can be performed by the security data processing engine 141, which can employ rule engines and/or AI-based models to compute the risk scores. In some implementations, the engine 141 can use the signal metadata to assign a signal risk score (e.g., form the range of 0 to 100) to one or more security signals. In an illustrative example, if an alert risk score is specified, it can be normalized to the chosen scale (e.g., 0 to 100) and assigned as the signal risk score.

In another illustrative example, if the signal priority and a signal severity have been specified by the signal metadata, each of the priority and severity values can be translated to a chosen scale (e.g., 0 to 10), and the product of the two numeric values can be assigned as a signal risk score. For example, if the signal priority is high (translated to 7) and the signal severity is medium (translated to 4), the value of 28=7×4 can be assigned as the signal risk score.

In some implementations, the security analytics platform can use one or more signal attributes to weigh an individual signal risk score. The risk score weights can be user-configurable thus allowing the users to adopt the risk scoring functionality to a specific computing environment.

In an illustrative example, a corresponding weight can be assigned to each type of signals (e.g., alert=1, detection signal=0.5). Accordingly, for a signal A of the type “alert” and individual risk score of 50, the individual weighted signal risk score would be equal to 50*1=50. Similarly, for a signal B of the type “detection signal” and individual risk score of 70, the individual weighted signal risk score would be equal to 70*0.5=35.

In some implementations, the security analytics platform can aggregate, over a chosen time window (e.g., 1 day, 7 days, 30 days), the computed individual signal risk scores, thus producing a combined weighted signal risk score. In an illustrative example, the computed weighted signal risk scores for signals that has occurred within a predefined time window (e.g., 7 days) can be added together, thus producing a combined weighted signal risk score:
Signal A: Weighted Individual Risk Score: 50, time=day 1
Signal B: Weighted Individual Risk Score: 25, time=day 3
Signal C: Weighted Individual Risk Score: 15, time=day 4
Signal D: Weighted Individual Risk Score: 75, time=day 5
Signal E: Weighted Individual Risk Score: 10, time=day 8

The combined weighted signal risk score: 165=50 (Signal 1)+25 (Signal 2)+15 (Signal 3)+75 (Signal 4).

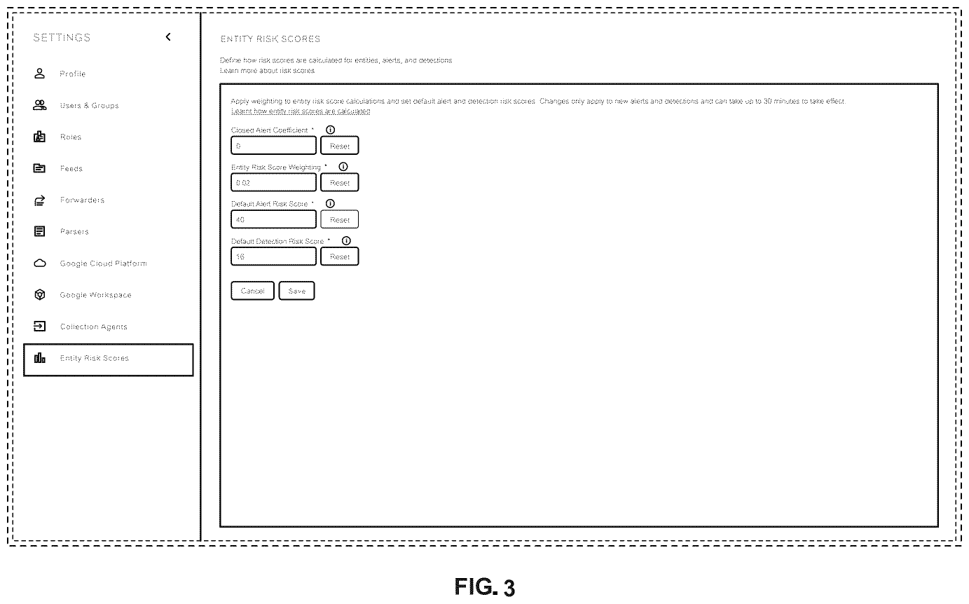

In some implementations, the security analytics platform can use one or more entity attributes to weight the combined weighted signal risk score. The entity attributes can be displayed and/or edited via a GUI, as schematically illustrated by FIG. 3, which depicts an example GUI for displaying and editing entity risk score parameters, generated by a security analytics platform operating in accordance with aspects of the present disclosure.

As noted herein above, the security analytics platform can compute entity risk scores by aggregating (e.g., summing) the risk scores of the signals occurring within a chosen time window. In some implementations, the security analytics platform can compute an entity's raw risk score using the following formula:

$${R}_{E} = {S}_{max} + d {\sum }_{i} {S}_{i}$$

where R_{E} is the entity risk score,
Sₘₐₓ is the maximum risk score among the risk score of the signals (detections) associated with the entity,
ΣᵢSᵢ is the sum of risk scores of the remaining signals associated with the entity, and
d is the damping factor.

The damping factor can be a user-configurable value from the range of 0 to 1, to reflect specific operational needs. The damping factor of 0 would result in the computed risk score being equal to the maximum risk score among the risk score of the signals (detections) associated with the entity. Conversely, the damping factor of 0 would result in the raw risk score being equal to the sum of all the detection risk scores for the entity. Accordingly, the damping factor exceeding 0 but less than 1 would result in increasing the contribution from risk scores of non-maximum signals as the damping factor increases.

In some implementations, for closed detections or alerts, the security analytics platform can apply a closed alert coefficient to the computed risk score. “Closed” alert refers to an alert that is no longer active (e.g., since the conditions leading to the alert are no longer present). Accordingly, the adjusted final score can be computed as:

$${S}_{A} = {k}_{CA} {S}_{0}$$

where S_{A} is the adjusted risk score,
k_{CA} is the closed alert coefficient, and
S₀ is the initial risk score.

The CAC can be a user-configurable value from the range of 0 to 1, to reflect specific operational needs.

As noted herein above, the security analytics platform can compute entity risk scores by aggregating the risk scores of the signals occurring within a chosen time window. Notably, different time windows can produce different entity risk scores, thus facilitating identifications of different types of threats. In an illustrative example, analyzing signals over a one-day window can identify an intense brute force attack that is perpetrated within a day, while analyzing signals over a thirty-day window can identify a low profile but consistent attack of equal or greater threat.

As the computed values of entity risk scores can vary dramatically, they can be normalized to a predefined range (e.g., 0-1000), which would facilitate comparing risk score changes of various entities. In some implementations, the security analytics platform can normalize raw scores using the following techniques: scaling by a multiplication factor; clipping extreme values; logarithmic scaling; and/or Z-score normalization. In some implementations, the security analytics platform can apply composite techniques, such as clipping followed by min-max normalization.

As the entity risk scores can be computationally expensive to generate, such scores can be computed for one or more predefined time windows, e.g., a one-day window, a seven-day window, a thirty-day window, and/or a ninety-day window. The risk score time windows can be selected and/or toggled between via a GUI of an entity risk dashboard.

In some implementations, the security analytics platform can precompute certain performance statistics that are otherwise computationally expensive. In an illustrative example, the security analytics platform can precompute the outbound, inbound, and internal network traffic volumes, grouped by entity, for one or more time windows. In an illustrative example, the security analytics platform can precompute the authentication and authorization event patterns, including success/failure statistics, grouped by entity, for one or more time windows. The precomputed statistics can be utilized for computing the entity risk scores over respective time windows.

In some implementations, the security analytics platform can store the risk score history for one or more entities for at least a predetermined period of time. The historical risk scores can be visually rendered via a GUI of an entity risk dashboard.

In some implementations, the security analytics platform can use the historical risk scores as detection primitives in the detection logic, thus facilitating identification of otherwise potentially undetectable risky events. In an illustrative example, the security analytics platform can generate an alert if a risk score for an entity has increased by more than a predefined threshold in a given time window. In another illustrative example, the security analytics platform can generate an alert if a risk score for an entity exceeds a predefined risk score threshold value. In another illustrative example, the security analytics platform can generate an alert if an entity belongs to a predefined group and the risk score for the entity a predefined risk score threshold value. In another illustrative example, the security analytics platform can generate an alert if an entity performs at least one specified action and the entity risk score exceeds a predefined risk score threshold value.

In some implementations, the security analytics platform can apply the risk score computation logic to different types of entities, such as, e.g., organizations, organizational units, groups, etc.

In some implementations, the security analytics platform can apply the risk score computation logic to different types of aggregations of signals. In an illustrative example, the signals can be grouped into cases (rather than entities), the risk score computation logic can be utilized for computing case risk scores. In another illustrative example, the risk score computation logic can be applied to Tactics, Techniques, and Procedures (TTP) of known types of cyberattacks.

As noted herein above, the security analytics platform can visually render the computed entity risk scores in visual associations with various other entity attributes.

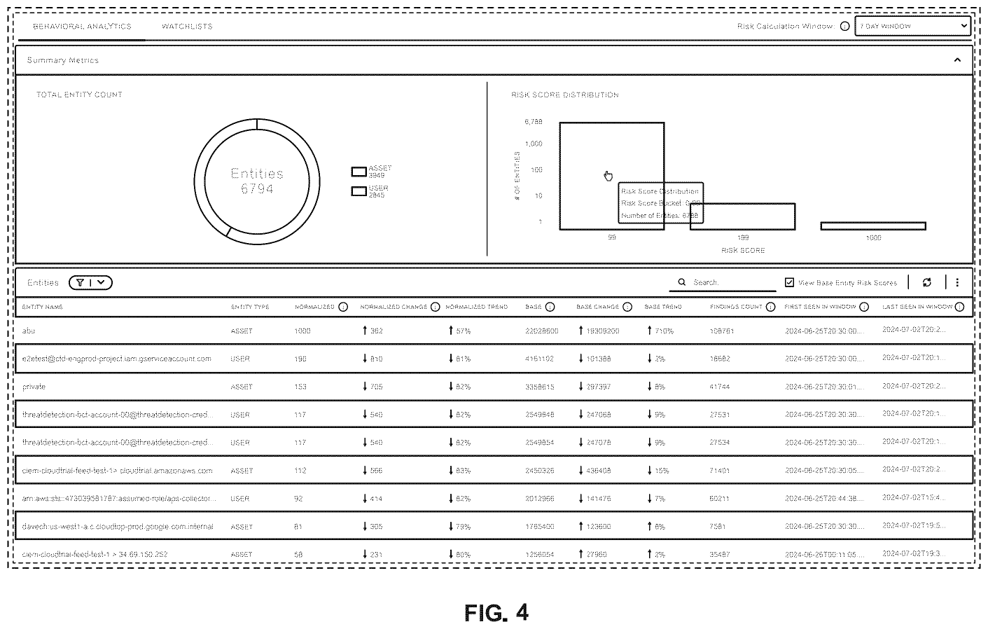

In some implementations, the security analytics platform can visually render an entity list view which includes a list of entities filtered by various user-selectable attributes (e.g., entity type, location, organizational unit, alert type, risk score, etc.), as schematically illustrated by FIG. 4, which depicts an example GUI visually representing various UEBA metrics. In some implementations, the entity list view can be extended to include the risk score and the change of the risk score within a user-specified time window (e.g., one day, seven days, and/or 30 days).

In some implementations, the risk values displayed in the entity list view can be sorted and/or filtered, thus enabling the user, e.g., to identify the entities that exhibited the highest risk scores within a specified time window, identify the entities that exhibited the largest changes of their risk scores within the specified time window, filter out entities that consistently exhibit high risk scores, etc.

In an illustrative example, the security analytics platform can visually render an alert list view which includes a list of alerts filtered by various user-selectable attributes (e.g., time window, alert type, entity type, location, organizational unit, risk score, etc.).

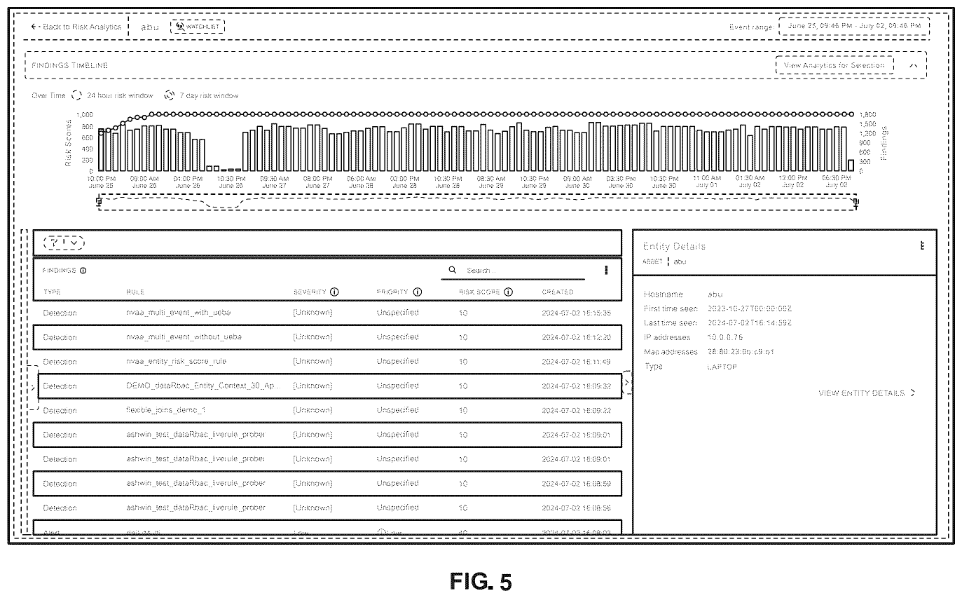

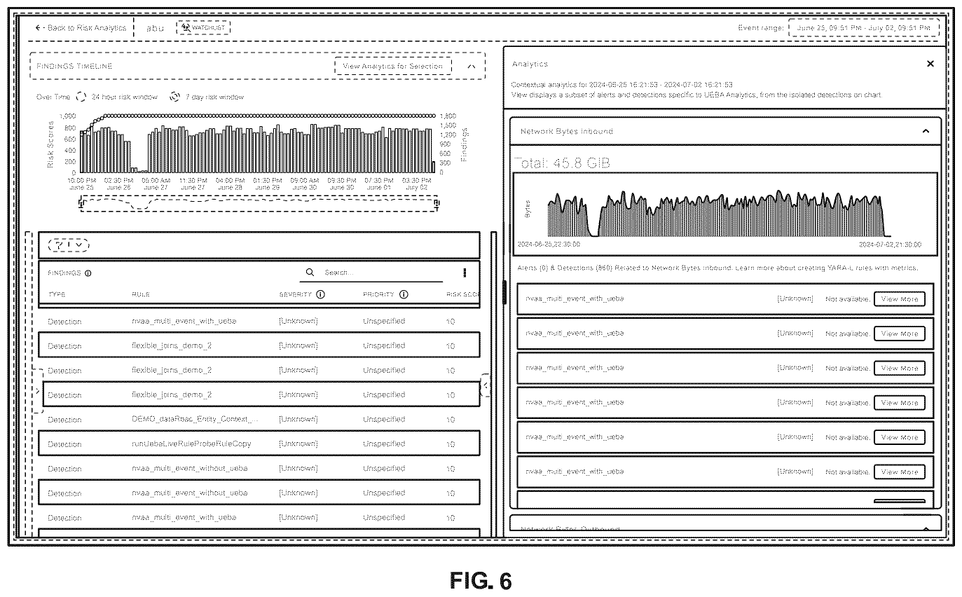

In an illustrative example, the security analytics platform can visually render an entity details view which includes the attributes of a given entity and a filtered list, together with the associated time-series chart, of the relevant signals in a given time range. In some implementations, the entity details view can be extended to include the risk score and the change of the risk score within a user-specified time window (e.g., one day, seven days, and/or 30 days) as schematically illustrated by FIG. 5, which depicts an example GUI visually representing the risk score and findings timeline generated by a security analytics platform operating in accordance with aspects of the present disclosure. In another illustrative example, the security analytics platform can visually render the risk score and findings timeline in a visual association with a chosen parameter timeline, as schematically illustrated by FIG. 6, which depicts an example GUI visually representing the risk score and findings timeline in a visual association with a chosen parameter timeline. In some implementations, the current risk scores can be overlaid over the time-series chart to show the risk score changes within the depicted time window and provide insights on what signals have affected the risk scores.

In an illustrative example, one or more of the specified security entities can be referenced by a security watchlist maintained by the security analytics platform. The security analytics platform can use watchlists to modify (e.g., elevate or suppress) the magnitude of the perceived risk associated with the entity.

A security watchlist can include a list of entities and associated metadata. The security analytics platform can implement various watchlist management functions, including creating, modifying, and deleting watchlists.

In an illustrative example, a security watchlist can be created or modified by a configurable logic of the security analytics platform (e.g., a rule engine evaluating one or more rule sets). Each rule can specify a logical condition defined on values of entity attributes and can further specify a watchlist to which the entities satisfying the logical condition should be added. In an illustrative example, the security analytics platform can, responsive to determining that values of one or more attributes of a given entity satisfy a logical condition specified by a watchlist membership rule, append the entity to the watchlist specified by the watchlist membership rule. In another illustrative example, responsive to determining that values of one or more attributes of a given entity fail to satisfy a logical condition specified by a watchlist membership rule, the security analytics platform can remove the entity from the watchlist specified by the watchlist membership rule.

In some implementations, a security watchlist can be created or modified by an AI-based model which receives, as its input, a set of security data items including values of one or more parameters of one or more entities, and produces an output specifying one or more watchlist creation or modification operations (e.g., append a specified entity to a specified watchlist, remove a specified entity from a specified watchlist, create a new watchlist and append a specified entity to it, etc.).

In some implementations, upon appending an entity to a watchlist, the security risk value associated with the entity may be modified based on the values of one or more parameters of the security watchlist (e.g., multiplied by a specified factor), as described in more detail herein below.

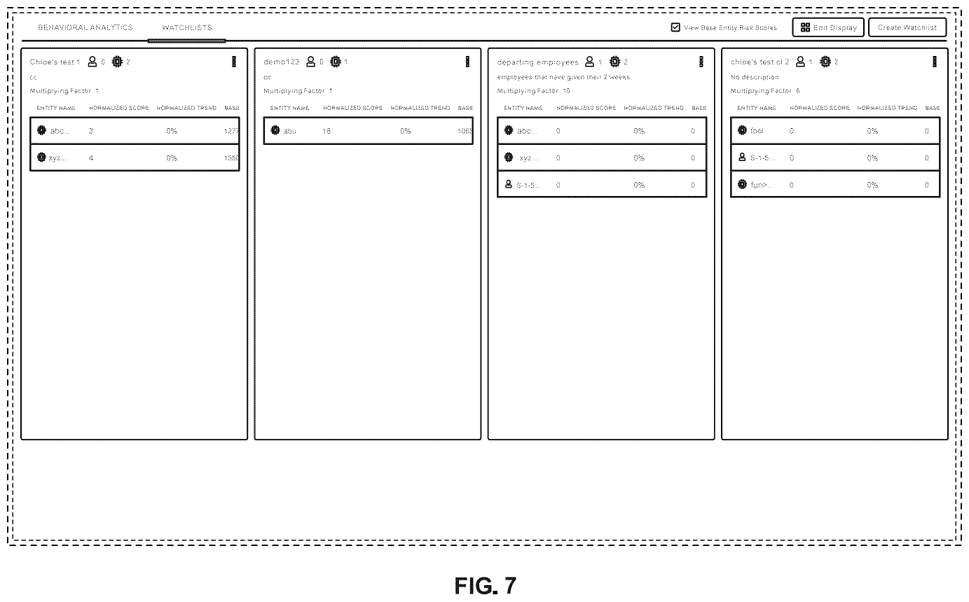

In some implementations, a security watchlist can be created or modified via a GUI of a watchlist management dashboard which can display one or more user-selectable watchlist. For each displayed watchlist, the watchlist management dashboard can display a list of entities that are members of the watchlist, and their respective entity risk scores, as schematically illustrated by FIG. 7, which depicts an example GUI for displaying member entities of several watchlists generated by a security analytics platform operating in accordance with aspects of the present disclosure.

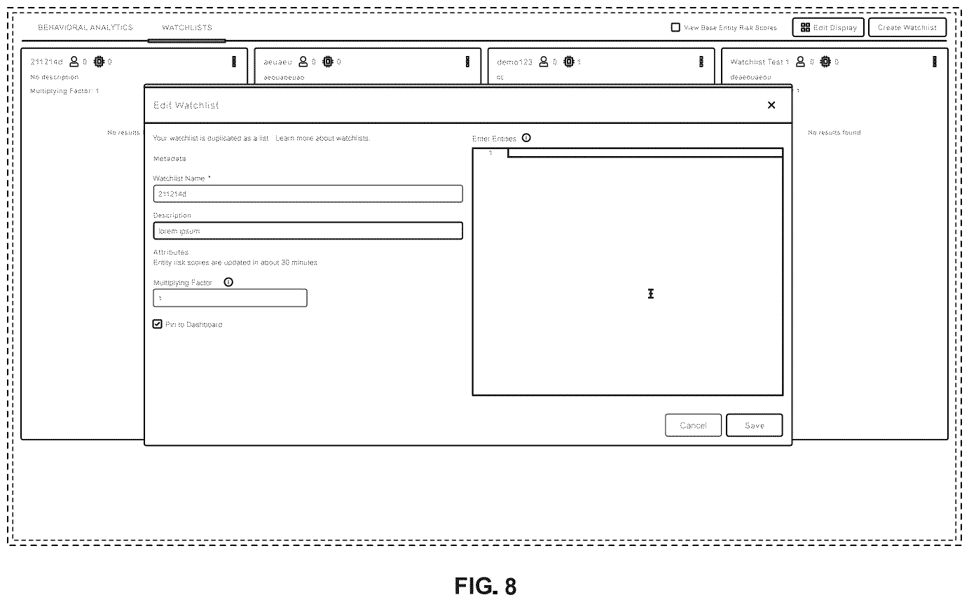

The watchlist management dashboard can also display at least a subset of the watchlist metadata, which can specify the watchlist name, purpose, creation time, modification time, watchlist owner, and/or watchlist state (e.g., enabled/disabled). In some implementations, the watchlist metadata can specify the watchlist attributes, e.g., alert risk score weight, detection risk score weights, ignore alert risk score flags, and/or values of other parameters for a configurable logic, as schematically illustrated by FIG. 8, which depicts an example GUI for editing parameters of a watchlist, generated by a security analytics platform operating in accordance with aspects of the present disclosure.

In some implementations, for each displayed watchlist, the watchlist management dashboard can also display at least a subset of the entity metadata for one or more entities on the watchlist. The entity metadata can include the entity symbolic name and alphanumeric identifier, the timestamp of the entity addition to the watchlist, etc.

In an illustrative example, the security analytics platform can, responsive to receiving a GUI command selecting one or more entities and identifying a watchlist, append the selected entities to the identified watchlist. In another illustrative example, the security analytics platform can, responsive to receiving a GUI command selecting one or more entities from a watchlist, remove the selected entities from the watchlist.

In some implementations, a security watchlist can be created or modified via a GUI rendering various contextual view, such as an alert graph view, and alert details view, an entity details view, etc.

In some implementations, a security watchlist can be created or modified via a watchlist management API. In an illustrative example, the security analytics platform can, responsive to receiving an API call identifying one or more entities and a watchlist, append the identified entities to the watchlist. In another illustrative example, the security analytics platform can, responsive to receiving an API call identifying one or more entities from a watchlist, remove the identified entities from the watchlist.

In some implementations, the security analytics platform can restrict watchlist access and management to authorized users. The security analytics platform can enforce access control for: creating, updating, and deleting watchlists; viewing watchlist metadata or membership; adding or removing entities from watchlists; and/or various other actions.

In some implementations, the security analytics platform can maintain watchlist audit logs. Each record of an audit log can describe the action taken, the impacted entities, the acting user or system, and the timestamp. The logged watchlist interactions can include: watchlist view, create, and delete operations; watchlist metadata updates; watchlist membership changes; and/or various other actions.

In some implementations, the security analytics platform can implement various use cases leveraging watchlists. In an illustrative example, the security analytics platform can utilize the watchlists for modifying the risk scores for entities based on their watchlist membership. In another illustrative example, the security analytics platform can amplify alert risk scores and/or or detection risk scores for the entities that are present in a watchlist. In another illustrative example, the security analytics platform can suppress risk scores for known benign high-risk actions (e.g., certain administrative actions within the computing environment). In another illustrative example, the security analytics platform can trigger an alert for a given entity conditionally, responsive to verifying the membership of the entity in a specified watchlist.

In some implementations, the security analytics platform can apply one or more watchlist attributes to modify the risk scores of the entities that are members of the watchlist. In an illustrative example, one or more watchlist attributes can specify respective multiplicative factors for adjusting the weights of certain signals that are utilized for computing a risk score of an entity referenced by the watchlist. In another illustrative example, a watchlist attribute can specify a multiplicative factor for adjusting the risk score of an entity referenced by the watchlist. In some implementations, the security analytics platform can apply the multiplicative factors at the time of risk score computation without modifying the underlying alert risk scores or detection risk scores.

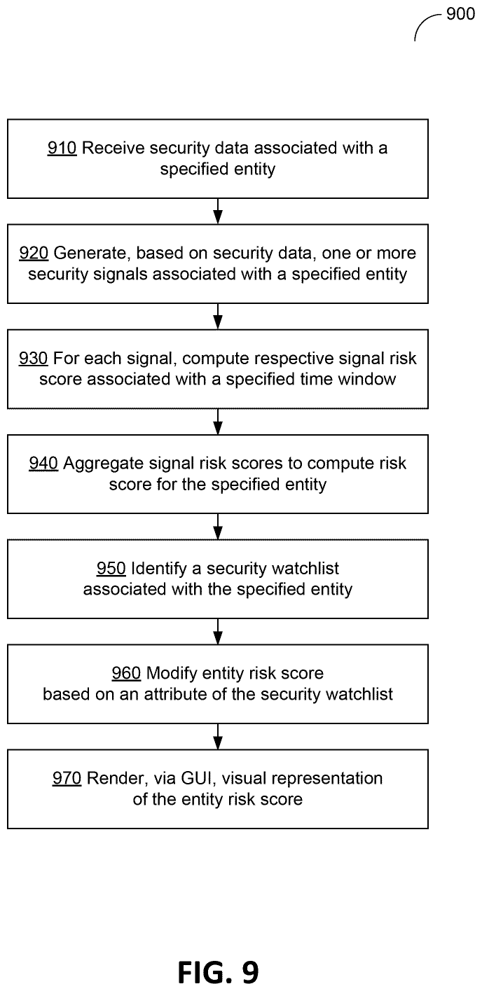

FIG. 9 is a high-level flow diagram of an example method 900 of computing entity risk scores by a security analytics platform operating in accordance with aspects of the present disclosure. The method 900 may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 900 may be performed by a single processing thread. Alternatively, method 900 may be performed by two or more processing threads, each thread executing one or more individual functions, routines, subroutines, or operations of the method. In an illustrative example, the processing threads implementing method 900 may be synchronized (e.g., using semaphores, critical sections, and/or other thread synchronization mechanisms). Alternatively, the processing threads implementing method 900 may be executed asynchronously with respect to each other. In some implementations, the method 900 is performed by a security analytics platform (e.g., platform 120 of FIG. 1). At least some of the operations of method 900 may be performed by the server computing device (e.g., server 130-140 of FIG. 1). Operations of the method 900 may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 910, the processing logic implementing the method receives security data associated with a specified entity. The entity may be specified, e.g., by a GUI command selecting an entity from a list of entities associated with a computing environment of a client organization, as described in more detail herein above.

At operation 920, the processing logic generates, based on at least a subset of the security data, one or more security signals associated with the specified entity and occurring within a specified time window. Examples of security signals include an event, a detection (e.g., of a security threat), an alert (e.g., of a security threat), a third party signal, etc. The time window may be specified, e.g., by a GUI command selecting the time window from a list of available time windows or providing custom dates and times identifying the time window. In some implementations, the security signals can be generated by a set of signal generation rules. In an illustrative example, responsive to determining that values of one or more security data items associated with the specified entity satisfy a logical condition specified by a signal creation rule, the processing logic can generate a signal specified by the signal creation rule. In another illustrative example, responsive to determining that values of one or more security data items associated with the specified entity satisfy a logical condition specified by a signal attribute computation rule, the processing logic can compute one or more signal attribute values to be assigned to respective one or more signal attributes associated with the signal. Examples of signal attribute values include, e.g., signal priority and severity, as described in more detail herein above.

At operation 930, the processing logic computing, for each security signal of the one or more security signals, a respective risk score associated with the specified time window. In some implementations, a risk score associated with a signal can be computed by translating the signal priority and severity values to a chosen scale (e.g., 0 to 10), and assigning the product of the two numeric values as the signal risk score. In some implementations, one or more signal attributes can be utilized to weigh an individual signal risk score. In an illustrative example, a corresponding weight can be assigned to each type of signals (e.g., alert=1, detection signal=0.5). In some implementations, the computed individual signal risk scores can be aggregated, over a chosen time window (e.g., 1 day, 7 days, 30 days), thus producing a combined weighted signal risk score. In an illustrative example, the computed weighted signal risk scores for signals that has occurred within a predefined time window (e.g., 7 days) can be added together, thus producing a combined weighted signal risk score, as described in more detail herein above.

At operation 940, the processing logic computes, by aggregating (e.g., summing) risk scores associated with the one or more security signals, a risk score associated with the specified entity for the specified time window, as described in more detail herein above.

At operation 950, the processing logic identifies a security watchlist associated with the specified entity. In an illustrative example, the processing logic identifies the security watchlist associated with the entity by inspecting the entity metadata. In an illustrative example, the processing logic identifies the security watchlist associated with the entity by iterating over the existing watchlists and inspecting the list of entities referenced by each watchlists. In some implementations, the watchlist is identified by a watchlist membership rule. Accordingly, responsive to determining that values of one or more attributes of the specified entity satisfy a logical condition specified by the watchlist membership rule, the processing logic can associate the specified entity with the watchlist. Conversely, responsive to determining that values of one or more attributes of the given entity fail to satisfy a logical condition specified by the watchlist membership rule, the processing logic can disassociate the specified entity from the watchlist, as described in more detail herein above.

At operation 960, the processing logic modifies, based on an attribute of a security watchlist associated with the specified entity, the risk score of the specified entity. In an illustrative example, a watchlist attribute can specify a multiplicative factor for adjusting the risk score of an entity referenced by the watchlist. Accordingly, the computed risk score can be multiplied by the attribute of the watchlist, thus producing the final risk score for the entity, as described in more detail herein above.

At operation 970, the processing logic renders, via a graphical user interface (GUI), a visual representation of the security risk in a visual association with a timeline comprising the specified time window, as described in more detail herein above.

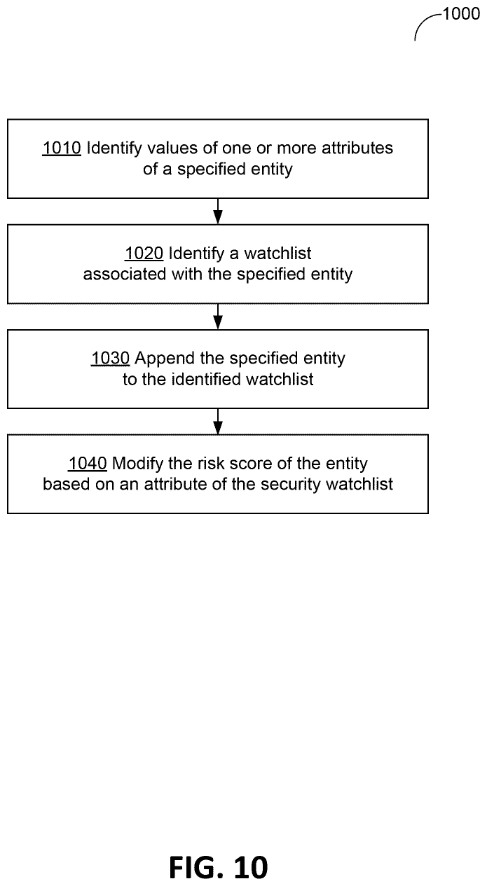

FIG. 10 is a high-level flow diagram of an example method 1000 of watchlist management by a security analytics platform operating in accordance with aspects of the present disclosure. The method 1000 may be performed by processing logic that may include hardware (e.g., general purpose or specialized processing devices, circuitry, dedicated logic, programmable logic, microcode, integrated circuits, etc.), software (e.g., instructions run or executed on a processing device), or various combinations thereof. In some implementations, method 1000 may be performed by a single processing thread. Alternatively, method 1000 may be performed by two or more processing threads, each thread executing one or more individual functions, routines, subroutines, or operations of the method. In an illustrative example, the processing threads implementing method 1000 may be synchronized (e.g., using semaphores, critical sections, and/or other thread synchronization mechanisms). Alternatively, the processing threads implementing method 1000 may be executed asynchronously with respect to each other. In some implementations, the method 1000 is performed by a security analytics platform (e.g., platform 120 of FIG. 1). At least some of the operations of method 1000 may be performed by the server computing device (e.g., server 130-140 of FIG. 1). Operations of the method 1000 may be specified by a sequence of command codes, which the processing logic may retrieve from a dedicated storage location. Although shown in a particular sequence or order, unless otherwise specified, the order of the operations may be modified. Thus, the illustrated implementations should be understood only as examples, and the illustrated operations may be performed in a different order, and some operations may be performed in parallel. Additionally, one or more operations may be omitted in various implementations. Thus, not all operations are required in every implementation.

At operation 1010, the processing logic implementing the method identifies values of one or more attributes of the specified entity. The entity may be specified, e.g., by a GUI command selecting an entity from a list of entities associated with a computing environment of a client organization. In an illustrative example, the processing logic may identify the values of the attributes by inspecting the metadata associated with the entity, as described in more detail herein above.

At operation 1020, the processing logic identifies a watchlist associated with the specified entity. In an illustrative example, the processing logic can determine that a given watchlist is associated with the specified entity if a watchlist membership rule of the given watchlist has its logical condition satisfied by the values of the attributes of the specified entity. In another illustrative example, the processing logic can iterate over the watchlist membership rules of the existing watchlist and evaluate their logical conditions against the values of the attributes of the specified entity. In another illustrative example, responsive to determining that values of one or more attributes of the specified entity satisfy a logical condition specified by the watchlist membership rule, the processing logic can associate the specified entity with the watchlist. Conversely, responsive to determining that values of one or more attributes of the given entity fail to satisfy a logical condition specified by the watchlist membership rule, the processing logic can disassociate the specified entity from the watchlist, as described in more detail herein above.

At operation 1030, the processing logic appends the specified entity to the identified watchlist, as described in more detail herein above.

At operation 1040, the processing logic modifies, based on an attribute of the identified watchlist, a risk score of the specified entity. In an illustrative example, the watchlist attribute can specify a multiplicative factor for adjusting the risk score of an entity referenced by the watchlist. Accordingly, the computed risk score can be multiplied by the attribute of the watchlist, thus producing the final risk score for the entity, as described in more detail herein above.

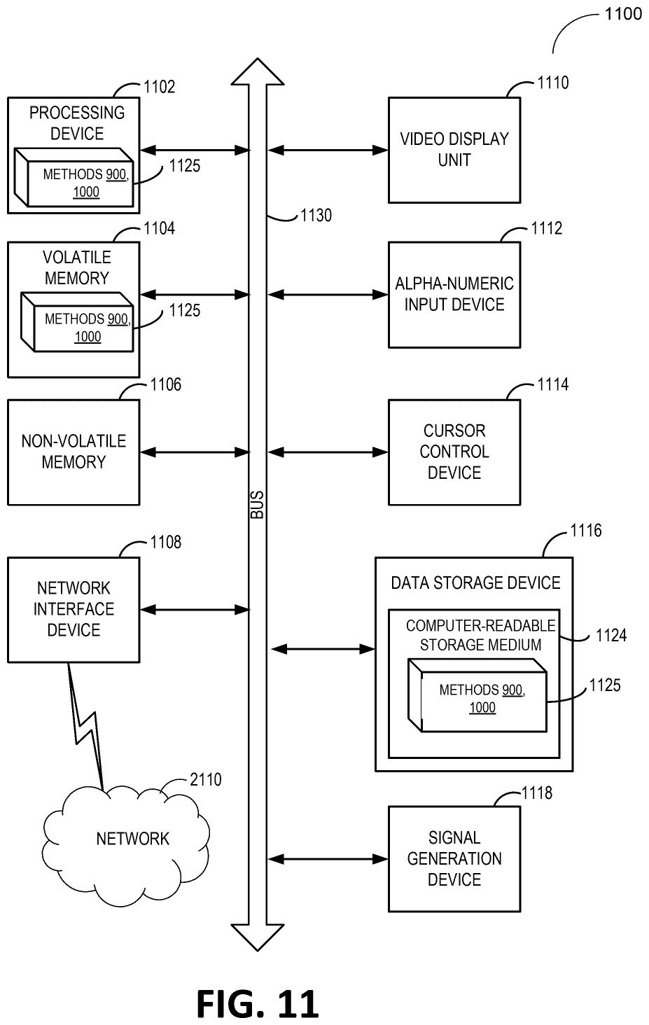

FIG. 11 is a block diagram illustrating an example of a computer system 1100, according to aspects of the disclosure. The computer system 1100 can correspond to one or more computers implementing the security analytics platform 120, servers 130, 140, and/or client devices 102A-N, described in FIG. 1. Computer system 1100 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methods discussed herein.

The computer system 1100 includes a processing device 1102 (e.g., a processor), a main memory 1104 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 1106 (e.g., flash memory, static random access memory (SRAM), etc.), and a data storage device 1116, which communicate with each other via a bus 1130. In some implementations, the main memory 1104 can be a non-transitory computer readable storage medium.

Processing device 1102 represents one or more general-purpose processing devices such as a microprocessor, central processing unit, or the like. More specifically, processing device 1102 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 can also be one or more special-purpose processing devices such as an application specific integrated circuit (ASIC), a field programmable gate array (FPGA), a digital signal processor (DSP), network processor, or the like. The processing device 1102 is configured to execute network interface device 1108 (e.g., for synchronizing data between platforms) for performing the operations discussed herein. The processing device 1102 can be configured to execute instructions 1125 stored in main memory 1104. Non-volatile memory 1106 can store the instructions 1125 when they are not being executed, and can store additional system data that can be accessed by processing device 1102.

The computer system 1100 can further include a network interface device 1108. The computer system 1100 also can include a video display unit 1110 (e.g., a liquid crystal display (LCD) or a cathode ray tube (CRT)), an input device 1112 (e.g., a keyboard, and alphanumeric keyboard, a motion sensing input device, touch screen), a cursor control device 1114 (e.g., a mouse), and an acoustic signal generation device 1118 (e.g., a speaker).

The data storage device 1116 can include a computer-readable storage medium 1124 (e.g., a non-transitory machine-readable storage medium) on which is stored one or more sets of instructions 1125 (e.g., for volumetric presentation of high cardinality context data and transparent storage into a graph backend) embodying any one or more of the methods or functions described herein, including methods 900 and 1000. The instructions can also reside, completely or at least partially, within the main memory 1104 and/or within the processing device 1102 during execution thereof by the computer system 1100, the main memory 1104 and the processing device 1102 also constituting machine-readable storage media. The instructions can further be transmitted or received over a network 1120 via the network interface device 1108.

While the computer-readable storage medium 1124 (machine-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methods of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one implementation,” “an implementation,” or “an implementation,” means that a specific feature, structure, or characteristic described in connection with the implementation and/or implementation is included in at least one implementation and/or implementation. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
receiving, by one or more processing devices of a security analytics platform, security data associated with a specified entity;
generating, based on at least a subset of the security data, one or more security signals associated with the specified entity and occurring within a specified time window;
computing, for each security signal of the one or more security signals, a respective risk score associated with the specified time window;
computing, by aggregating risk scores associated with the one or more security signals, a risk score associated with the specified entity for the specified time window; and
modifying, based on an attribute of a security watchlist associated with the specified entity, the risk score of the specified entity.

2. The method of claim 1, wherein generating the one or more security signals further comprises:
responsive to determining that values of one or more security data items associated with the specified entity satisfy a logical condition specified by a signal creation rule, generating a signal specified by the signal creation rule.

3. The method of claim 2, wherein generating the one or more security signals further comprises:
responsive to determining that values of one or more security data items associated with the specified entity satisfy a logical condition specified by a signal attribute computation rule, computing one or more signal attribute values to be assigned to respective one or more signal attributes associated with the signal.

4. The method of claim 1, wherein the watchlist is identified by a watchlist membership rule, the method further comprising:
responsive to determining that values of one or more attributes of the specified entity satisfy a logical condition specified by the watchlist membership rule, associating the specified entity with the watchlist.

5. The method of claim 1, wherein the watchlist is identified by a watchlist membership rule, the method further comprising:
responsive to determining that values of one or more attributes of the specified entity fail to satisfy a logical condition specified by the watchlist membership rule, disassociating the specified entity from the watchlist.

6. The method of claim 1, wherein modifying the risk score of the specified entity further comprises:
multiplying the risk score by the attribute of the security watchlist.

7. The method of claim 1, further comprising:
rendering, via a graphical user interface (GUI) a visual representation of the security risk in visual association with a timeline comprising the specified time window.

8. A system comprising:
a memory; and
a processing device coupled to the memory, the processing device to perform operations comprising:
receiving security data associated with a specified entity;
generating, based on at least a subset of the security data, one or more security signals associated with the specified entity and occurring within a specified time window;
computing, for each security signal of the one or more security signals, a respective risk score associated with the specified time window;
computing, by aggregating risk scores associated with the one or more security signals, a risk score associated with the specified entity for the specified time window; and
modifying, based on an attribute of a security watchlist associated with the specified entity, the risk score of the specified entity.

9. The system of claim 8, wherein generating the one or more security signals further comprises:
responsive to determining that values of one or more security data items associated with the specified entity satisfy a logical condition specified by a signal creation rule, generate a signal specified by the signal creation rule.

10. The system of claim 9, wherein generating the one or more security signals further comprises:
responsive to determining that values of one or more security data items associated with the specified entity satisfy a logical condition specified by a signal attribute computation rule, compute one or more signal attribute values to be assigned to respective one or more signal attributes associated with the signal.

11. The system of claim 8, wherein the watchlist is identified by a watchlist membership rule, the operations further comprising:
responsive to determining that values of one or more attributes of the specified entity satisfy a logical condition specified by the watchlist membership rule, associating the specified entity with the watchlist.

12. The system of claim 8, wherein the watchlist is identified by a watchlist membership rule, the operations further comprising:
responsive to determining that values of one or more attributes of the given entity fail to satisfy a logical condition specified by the watchlist membership rule, disassociating the specified entity from the watchlist.

13. The system of claim 8, wherein modifying the risk score of the specified entity further comprises:
multiplying the risk score by the attribute of the security watchlist.

14. The system of claim 8, wherein the operations further comprise:
rendering, via a graphical user interface (GUI) a visual representation of the security risk in visual association with a timeline comprising the specified time window.

15. A non-transitory computer-readable storage medium comprising executable instructions that, when executed by a processing device of a server, cause the processing device to perform operations comprising:
receiving security data associated with a specified entity;
generating, based on at least a subset of the security data, one or more security signals associated with the specified entity and occurring within a specified time window;
computing, for each security signal of the one or more security signals, a respective risk score associated with the specified time window;
computing, by aggregating risk scores associated with the one or more security signals, a risk score associated with the specified entity for the specified time window; and
modifying, based on an attribute of a security watchlist associated with the specified entity, the risk score of the specified entity.

16. The non-transitory computer-readable storage medium of claim 15, wherein generating the one or more security signals further comprises:
responsive to determining that values of one or more security data items associated with the specified entity satisfy a logical condition specified by a signal creation rule, generating a signal specified by the signal creation rule.

17. The non-transitory computer-readable storage medium of claim 15, wherein the watchlist is identified by a watchlist membership rule, the operations further comprising:
responsive to determining that values of one or more attributes of the specified entity satisfy a logical condition specified by the watchlist membership rule, associating the specified entity with the watchlist.

18. The non-transitory computer-readable storage medium of claim 15, wherein the watchlist is identified by a watchlist membership rule, the operations further comprising:
responsive to determining that values of one or more attributes of the specified entity fail to satisfy a logical condition specified by the watchlist membership rule, disassociating the specified entity from the watchlist.

19. The non-transitory computer-readable storage medium of claim 15, wherein modifying the risk score of the specified entity further comprises:
multiplying the risk score by the attribute of the security watchlist.

20. The non-transitory computer-readable storage medium of claim 15, wherein the operations further comprise:
rendering, via a graphical user interface (GUI) a visual representation of the security risk in visual association with a timeline comprising the specified time window.
